(19) United States
(12) Patent Application Publication
(10) Pub. No.: US 2009/0142645 A1
(43) Pub. Date: Jun. 4, 2009

(54) Bipolar plate, method for producing bipolar plate and PEM fuel cell

(75) Inventors: Samu Aalto, Tampere (FI); Pertti Kauranen, Tampere (FI); Jari Ihonen, Espoo (FI); Pasi Kosonen, Viiala (FI)

Correspondence Address: VENABLE LLP, P.O. BOX 34385, WASHINGTON, DC, 20043-9998, US

(73) Assignee: Valtion Teknillinen Tutkimuskeskus, Espoo (FI)

(21) Appl. No.: 11/987,521

(22) Filed: Nov. 30, 2007

(51) Int. Cl. H01M 8/02; H01M 8/10; B29C 43/02; H01B 1/24

(52) U.S. Cl. 429/34; 429/30; 264/241; 252/511

(57) ABSTRACT

A bipolar plate made of a composition comprising at least an epoxy resin, graphite filler and a metal amine complex as a curing agent for the epoxy resin. The invention also relates to a method for producing a bipolar plate and to the use of the bipolar plates in PEM fuel cells.

### FIELD OF THE INVENTION

The present invention relates to a bipolar plate, a method for producing the bipolar plate and a PEM fuel cell using the bipolar plate.

### BACKGROUND OF THE INVENTION

A bipolar plate is a multifunctional component within the PEM (Proton Exchange Membrane, also called Polymer Electrolyte Membrane) fuel cell stack. It connects and separates the individual fuel cells in series to form the fuel cell stack with required voltage, aids uniform distribution of fuel gas and oxygen over the whole active surface area of the membrane electrode assemblies, conducts electrical current from the anode of one cell to the cathode of the next, facilitates water management within the cell, supports thin membrane and electrodes and clamping forces for the stack assembly, among other things.

In the fuel cells, metallic bipolar plates, carbon bipolar plates, and carbon composite bipolar plates are commonly used as the bipolar plates. Metals are selected due to their inherent conductivity and easy processability. However, the numerous chemicals that interact within the fuel cell and the production of water from the reaction caused severe problems with metal corrosion. Disadvantages of the carbon bipolar plates are high production costs and low mechanical strength.

The bipolar plates constitute about 25% of the cost of state of the art PEM fuel cells by reason of production technology. Bipolar plates constitute also most of the weight of the PEM fuel cell stacks. Consequently, more cost-effective materials and production technologies are urgently needed to bring down the plate cost.

Furthermore, it is a major trend in PEM fuel cell development to raise the fuel cell temperature from the present 80° C. to 120-150° C. which improves the CO tolerance of the cell (less sensitive to catalysts poisoning) and heat removal from the stack (especially important for the automotive application). The bipolar plates which are machined from graphite are commonly used in PEM fuel cells operating around 150° C.

The polymer composite materials can alleviate some of the concerns related to weight and volume, and hence the cost of fuel cell stacks. A variety of composite bipolar plates have been developed, which are mostly made by compression moulding of polymer matrices (thermoplastic and thermoset resins) filled with conductive particles such as graphite powders. As most polymers have extremely low electronic conductivity, excessive conductive filler has to be incorporated, resulting in a high viscosity of the filled polymer and hence making it very difficult to process. In other words, one problem with the carbon composite bipolar plates is low electrical conductivity.

Another problem in such above mentioned composite bipolar plates is that they have insufficient storage stability. Amines are usually used as the curing agent in composite bipolar compounds and it is activated already during the mixing of the components. In addition, conventional composite bipolar plate materials are not stable at high operation temperatures.

In order to manufacture large numbers of bipolar plates cost-efficiently, the production process has to be capable of being run with very short cycle time.. Furthermore, high latency of the moulding composition is required to achieve this property profile.

### SUMMARY OF THE INVENTION

The aim of the present invention is to provide a novel carbon-filled composite material for PEM fuel cell bipolar plates in which the above-described problems of the prior art are substantially avoided. More precisely, the object is to provide a solvent-free, storage stable, rapidly curing epoxy resin system with high thermal stability and electrical conductivity which can be produced by an efficient process, in particular by the usual processes for producing epoxy moulding compositions.

According to the present invention, there is provided a bipolar plate made of a composition comprising at least an epoxy resin, graphite filler, and a metal amine complex as a curing agent for the epoxy resin.

The bipolar plate of the invention is especially suitable for using in PEM fuel cells.

The present invention further provides a method for producing a bipolar plate, which method comprises preparing a bipolar plate composition comprising at least an epoxy resin, graphite filler and a metal amine complex as a curing agent for the epoxy resin, and moulding the composition into the bipolar plate under suitable conditions.

The invention is a bipolar plate made of a graphite epoxy compound based on a low viscosity epoxy resin, a heat activated latent metal amine complex curing agent and a high loading of graphite filler. A low viscosity of the epoxy system provides a high degree of filling of graphite powder. Preferably, the degree of the filling is from 70 to 90% by volume of the composition. Any kind of solvents for lowering the viscosity of the epoxy system is not required, but all components of the epoxy system are involved in the crosslinking reaction. The high loading of the graphite filler provides good thermal stability and electrical conductivity of produced bipolar plates.

Preferred curing agents for epoxy resin are latent and heat activated metal amine complex curing agents. Latent curing agents are a class of the compounds that allow for the formulation of single part, self stable, epoxy resin systems. A preferred metal amine complex is boron trichloride monoethylamine complex (BCl₃-MEA), which is used merely for curing the epoxy resin. BCl₃-MEA is latent at room temperature and it is activated only at an elevated temperature. Curing will begin at the temperature of 120° C., but the epoxy system according to the invention is cured at the temperatures ranging from 120 to 190° C., preferably from 170° C. to 190° C.

The bipolar plate composition according to the invention is a chemically and physically stable material in a PEM fuel cell environment. The bipolar plates made of the composition according to the invention can be used at the fuel cell temperatures from −20° C to 160° C., i.e. in both low temperature and high temperature fuel cell applications. They are especially suitable for high operating temperatures, such as an operating temperature range from 120 to 160° C. Because of this, they are also applicable in automobile applications.

The bipolar plates according to the invention have some remarkable advantages compared to the existing bipolar plates, such as machined compressed graphite plates, metal plates or thermoplastic based composite plates. The bipolar plates according to the invention have high electrical and thermal conductive properties. They are easy to produce and the costs of the production are low by reason of the inexpensive raw materials (graphite powder and a binder) and a short production time. In addition, a latent metal amine complex curing agent provides long-standing storage periods without any special storage conditions, and therefore a mixed graphite epoxy composition can be stored under room temperature conditions. In addition, the bipolar plates, which are cured by using BCl₃-MEA as a curing agent, have a good resistance to hydrolysis which is an important property in the fuel cell environment.

The usability of the bipolar plates according to the invention is as good as corresponding thermoplastic based composite materials. However, the bipolar plates according to the invention have a better dimensional stability.

Furthermore, a metal amine complex curing agent allows a rapid temperature rise in the manufacturing process of the plates, and therefore, especially the manufacturing of the large-size kW-class fuel cells is possible in a short production time. Short manufacturing cycle times and fast curing times are one of the advantages of the invention.

The homogenous bipolar plates can be manufactured by compression moulding, and also large-size plates are possible to manufacture. The cured plate can be taken out from the mould when it is warm so that the dimensional accuracy of the plate does not change. Thus, the manufacturing process of the plates can also be simplified, because the plates manufactured by the method according to the invention do not require a long-running cooling stage after the moulding.

### DETAILED DESCRIPTION OF THE INVENTION

The present invention will be described in detail below.

A bipolar plate of the invention is made of a composition, which comprises at least an epoxy resin, graphite filler, and a metal amine complex as a curing agent for the epoxy resin.

More precisely, a suitable epoxy resin for preparing the composition is bisphenol A, bisphenol F or a mixture thereof. The ratio of bisphenol A to bisphenol F can vary between 0-100 parts by weight in the mixture.

Preferred curing agents for epoxy resin are latent and heat activated metal amine complex curing agents, especially boron trifluoride and boron trichloride-based amine complexes. Examples of the suitable boron trifluoride-based complexes are boron trifluoride monoethylamine complex (BF3-MEA), boron trifluoride benzyl amine/isopropyl amine complex (BF3-BA/iPA) and boron trifluoride isopropyl amine complex (BF3-iPA).

It is preferable to use boron trichloride monoethylamine complex (BCl₃-MEA) as the curing agent for the epoxy resin. BCl₃-MEA is latent at room temperature and it is activated at the temperature of approximately 120° C. However, the epoxy composition of invention is cured at temperatures ranging from 120 to 190° C., preferably from 170° C. to 190° C. This is a consequence of the fact that the glass transition temperature of the cross-linked epoxy system of the invention is typically 160 to 170° C., if the epoxy system is cured at the temperature of approximately 190° C. This gives a possibility to use the bipolar plate made of epoxy system according to the invention in high temperature fuel cell applications, such as operating temperatures ranging from 120 to 160° C.

The amount of the metal amine complex curing agent is preferably 2 to 10 parts by weight, more preferably 2 to 8 parts by weight of the bipolar plate composition.

The above described epoxy composition has a viscosity of 100 to 200 cPs at room temperature, which provides a high degree of filling of graphite powder. Any kind of solvents for lowering the viscosity of the epoxy system is not required, but all components of the epoxy system are involved in the crosslinking reaction. In other words, the composition is solvent-free.

The powdery filler used in the present invention has no particular restriction except for the particle diameter that will be explained later, as long as it is a powdery carbon filler having excellent electroconductibility. Filler to be mentioned include, for example, those made of natural graphite, flake graphite, synthetic graphite, carbon nanotubes and the like. Any one or a combination of two or more thereof may be used.

The amount of the filler is at least 50% by volume, preferably 50 to 90% by volume of the composition, more preferably 70 to 90% by volume of the composition. Use of the BCl₃-MEA as a curing agent with a high loading of graphite filler enables the crosslinking of the components.

The particle diameter of the filler is also significant in order to achieve homogenous mixing of the powdery filler with the binder component (i.e. epoxy resin and curing agent). The graphite powder used has an average particle diameter of 30 to 100 μm, preferably from 40 to 80 μm.

In addition, the bipolar plate composition may include, if necessary, epoxidized castor oil and/or epoxidized 1,6-hexanediole. Epoxidized castor oil can be added to the composition for improving the moistening of the particles and water resistance of the epoxy resin. The function of epoxidized 1,6-hexanediole is to lower of the viscosity of the epoxy system, if necessary, and to increase the strength. The content of these additives is generally from 0 to 15 parts by weight, preferably from 0 to 5 parts by weight of the composition.

The method for producing a bipolar plate comprises the following steps of:
preparing a bipolar plate composition comprising at least an epoxy resin, graphite filler, and a metal amine complex as a curing agent for the epoxy resin, and
moulding the composition into the bipolar plate at a temperature at which the composition cures.

At first, the epoxy resin and the metal amine complex curing agent is premixed and after that the powdery carbon filler is combined in the above-mentioned amount ratio with the premixed binder composition.

The mixing step can be conducted using a known mixing method. There is no particular restriction as to the mixing method. The composition is mixed at a temperature ranging from 0 to 60° C., preferably at the room temperature.

After the mixing, the uniform composition is moulded into the bipolar plate at temperatures ranging from 120 to 190° C., preferably from 170° C. to 190° C. The metal amine complex curing agent is activated chemically at the temperature of approximately 120° C. However, a higher curing temperature provides a short cycle time of the production process. For instance, at the temperature of 190° C., the epoxy system is cured in 60 to 120 seconds. Consequently, the composition can be compression moulded into the bipolar plate in a short cycle time of 30 to 300 seconds, depending on the plate size and design.

In the moulding, applied mould pressure is greater than 30 MPa, preferably greater than 40 MPa to gain a dense and low-porosity plate. As the method usable for this moulding operation, compression moulding is preferred.

For improved productivity, it is also possible to produce, in advance, a precursor or billet by a method such as tableting, extrusion moulding, pre-forming, roll press or the like, and then feed the precursor or billet into a moulding machine to obtain a fuel cell bipolar plate.

Due to the very latent nature of the premixed resin/curing agent mixture or the mixed graphite epoxy composition, its features will keep unchangeable at room temperature for even several months. Also, this extended pot life allows various rapid techniques for pre-compacting and degassing of the preform billets before compression moulding into complete bipolar plates.

According to the present method, a bipolar plate of various thicknesses and sizes can be easily obtained. The above described bipolar plate composition is preferred in plates, whose size is greater than DIN A5 (paper size standard). In these large-size plates, the compositions of the invention are suitable as replacements for thermoplastic based compositions in PEM fuel cell applications. However, the bipolar plate composition according to the invention is suitable for bipolar plates of any size.

By using the above described production method, bipolar plates of uniform quality and with high dimension stability can be produced. Furthermore, the cured plate can be taken out from the mould when it is warm so that the dimensional accuracy of the plate does not change. Consequently, the plates manufactured by the method according to the invention do not require a long-running cooling stage after the moulding.

The electrical conductivity of the bipolar plates of the invention is usually around 100 S/cm along the z-axis (through the plate) and usually around 250 S/cm along the x-y -plane (parallel to plate, surface resistance).

The present invention will be illustrated by the following example. However, this example is not to be construed as limiting the scope of the invention.

### EXAMPLE

In this example, one composition of the bipolar plate and the method for manufacturing the bipolar plate will be presented in detail. The amounts of the components will be given in parts by hundred (phr). The bipolar plate composition comprises the following components:

Resin:

| | |
|---|---|
| 30 phr | bisphenol F, |
| 60 phr | bisphenol A, and |
| 10 phr | epoxidized 1,6-hexanediol as reactive viscosity cutter |

Curing Agent:

| | |
|---|---|
| 8 phr | boron tricloride monoethyl amine |

Graphite filler having D90 (laser malvern) value of 60 to 80 microns.

At first, the resin composition and the curing agent are premixed and after that the premixed resin/curing agent mixture is combined with a ratio of 20 vol-% with 80 vol-% of graphite filler. This mixture is combined in a suitable batch mixer or extruder to receive a uniform mass.

The prepared mass is then applied in the compression mould and pressed into bipolar plate in elevated temperature. With the described resin/curing agent system, temperatures of 180 to 190° C. will cure the compacted system in less than 360 seconds, preferably in less than 180 seconds. The applied mould pressure should exceed 30 MPa, most preferably 40 MPa to gain dense and low-porosity plate.

The electrical conductivity of such a plate is usually around 100 S/cm, more than adequate for plates less than 10 mm thick and having a flexural strength of around 40 MPa.

What is claimed is:

1. A bipolar plate made of a composition comprising at least an epoxy resin, graphite filler and a metal amine complex as a curing agent for the epoxy resin.

2. The bipolar plate according to claim 1, wherein the metal amine complex is boron trifluoride or boron trichloride-based amine complex.

3. The bipolar plate according to claim 2, wherein the metal amine complex is boron trichloride monoethylamine complex.

4. The bipolar plate according to claim 1, wherein the composition comprises the metal amine complex in a quantity of 2 to 10 parts by weight.

5. The bipolar plate according to claim 4, wherein the composition comprises the metal amine complex in a quantity of 2 to 8 parts by weight of the composition.

6. The bipolar plate according to claim 1, wherein the epoxy resin is bisphenol A, bisphenol F or a mixture thereof.

7. The bipolar plate according to claim 1, wherein the amount of the graphite filler is from 50% to 90% by volume of the composition.

8. The bipolar plate according to claim 7, wherein the amount of the graphite filler is from 70 to 90% by volume of the composition.

9. The bipolar plate according to claim 1, wherein the graphite filler is graphite powder with an average particle diameter of 30 to 100 μm.

10. The bipolar plate according to claim 9, wherein the graphite filler is graphite powder with an average particle diameter of 40 to 80 μm.

11. The bipolar plate according to claim 1, wherein the composition comprises epoxidized castor oil.

12. The bipolar plate according to claim 1, wherein the composition comprises epoxidized 1,6-hexanediolb.

13. A method for producing a bipolar plate, comprising the steps of:
preparing a bipolar plate composition comprising at least an epoxy resin, graphite filler, a metal amine complex as a curing agent for the epoxy resin, and
moulding the composition into the bipolar plate.

14. The method according to claim 13, wherein the composition is prepared at temperatures ranging from 0 to 60° C.

15. The method according to claim 14, wherein the composition is prepared at room temperature.

16. The method according to claim 13, wherein the viscosity of the prepared composition is 100 to 200 cPs.

17. The method according to claim 13, wherein the composition is moulded at temperatures ranging from 120 to 190° C.

18. The method according to claim 17, wherein the composition is moulded at temperatures ranging from 170° C to 190° C.

19. The method according to claims 13, wherein the composition is moulded under a mould pressure of greater than 30 MPa.

20. The method according to claims 19, wherein the composition is moulded under a mould pressure of greater than 40 MPa.

21. The method according to claim 13, wherein the composition is formed into a precursor before the moulding.

22. The method according to claim 21, wherein the precursor is pre-compacted and degassed before it is moulded into the bipolar plate.

23. Use of a bipolar plate made of a composition comprising at least an epoxy resin, graphite filler, and a metal amine complex as a curing agent for the epoxy resin in a PEM fuel cell at the operating temperature from −20 to 160° C.

24. The use of the bipolar plate according to claim 23, wherein the operating temperature range is from 120 to 160° C.
